(19) United States
(12) Patent Application Publication
(10) Pub. No.: US 2001/0019484 A1
(43) Pub. Date: Sep. 6, 2001

(54) Headlight for vehicle operating in accordance with projection principle

(76) Inventors: Friedrich Schauwecker, Pfullingen (DE); Horst Oschmann, Struth-Helmershof (DE); Hartmut Stephan, Moorgrund Ot Etterwinden (DE)

Correspondence Address: STRIKER, STRIKER & STENBY, 103 East Neck Road, Huntington, NY, 11743, US

(21) Appl. No.: 09/772,371

(22) Filed: Jan. 30, 2001

(30) Foreign Application Priority Data
Feb. 3, 2000 (DE) 1 00 04 701.7

(51) Int. Cl. F21V 13/12; F21V 11/08

(52) U.S. Cl. 362/539; 362/516; 362/520; 362/308; 362/351

(57) ABSTRACT

A headlight for a vehicle operating in accordance with the projection principle has a light source, a reflector which reflects light emitted by the light source as a converging light beam, a screen arranged in a beam path of the light beam reflected by the reflector and screening a part of the light beam, a lens arranged after the screen in a light outlet direction for projecting an upper edge of the screen as a bright-dark limit of a light bundle exiting the headlight, so that a part of the light bundle reflected by the reflector illuminates at least a region arranged at a distance above the bright-dark limit, the screen being provided with at least one opening which is located at a defined region below the upper edge of the screen and formed so that a part of the light beam reflected by the reflector passes through the opening and illuminates at least one region above the bright-dark limit.

### BACKGROUND OF THE INVENTION

The present invention relates to a headlight for a vehicle, which operates in accordance with a projection principle.

Headlights of the above mentioned general type are known in the art. One of such headlights is disclosed for example in the German patent document DE 43 15 401 A1. This headlight has a light source and a reflector, with which the light emitted by the light source is reflected as a converging light beam. A screen is arranged in a beam path of the light beam reflected from the reflector. The screen screens a part of the light beam. A lens is arranged after the screen in the light outlet direction. An upper edge of the screen is projected by the lens as a bright-dark limit of the light beam exiting the headlight. The bright-dark limit prevents a blinding of the opposite traffic. A part of the light beam reflected by the reflector illuminates at least a region which is located at a distance above the bright-dark limit. Thereby a sufficient illumination of highly arranged traffic and information board is provided. In a known headlight a reflection element is arranged in the beam path of the light beam reflected by the reflector. It deviates a part of the light beam upwardly so that it illuminates a region above the bright-dark limit. The reflection element requires a higher manufacturing and mounting expenses and must be exactly adjusted to guarantee an illumination of a definite region. Moreover, with the reflection element a part of the light beam reflected by the reflector is deviated upwardly which would pass over the screen and contribute to the illumination about the bright-dark limit, so that the efficiency of the headlight is worsened by the reflection element.

German patent document DE 195 37 838 discloses a headlight operating in accordance with a projection principle. It has a screen arrangement with a stationary screen part and a movable screen part. Both screen parts have several slot-shaped openings. In a position for high beam, the openings for the stationary screen part are released by the movable screen part, so that light can pass through the screen arrangement and illuminate the regions above the bright-dark limit. In a position for low beam, the movable screen part in a position for low beam completely covers the opening of the stationary screen part, so that no light can pass through the screen arrangement. Light only can pass over the upper edge of the screen arrangement. An illumination of the definite region above the bright-dark limit is therefore not provided in this headlight.

### SUMMARY OF THE INVENTION

Accordingly, it is an object of present invention to provide a headlight of the above mentioned general type, which avoids the disadvantages of the prior art.

In keeping with these objects and with others which will become apparent hereinafter, one feature of present invention resides, briefly stated, in a headlight in which the screen has at least one opening at a defined distance under its upper edge, and a part of the light bundle reflected by the reflector passes through the opening, and at least a region above the bright-dark limit is thereby illuminated.

When the headlight is designed in accordance with the present invention, it has the advantage that the manufacturing and mounting expenses are reduced since for the illumination of the at least one region above the bright-dark limit no additional components are required.

The at least one opening in the screen can be simultaneously adjusted in its correct position for exactly adjusting the bright-dark limit with the adjustment which is required anyway. Moreover, the efficiency of the headlight is not negatively affected, since a part of the light beam reflected by the reflector can pass through the at least one opening, which otherwise is screened by the screen, so that the efficiency is improved.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a vertical longitudinal section of the headlight in accordance with the present invention;

FIG. 2 is a view showing a section of the inventive headlight taken along the line II-II in FIG. 1 in accordance with the first embodiment;

FIG. 3 is a view showing a measuring screen which is arranged at a distance from the headlight in accordance with the present invention and illuminated by a light produced by the headlight of the first embodiment;

FIG. 4 is a view showing a cross-section of the headlight taken along the line II-II in FIG. 1, in accordance with the second embodiment of the invention; and

FIG. 5 is a view showing a measuring screen illuminated by the light emitted by the headlight in accordance with the second embodiment of the present invention.

### DESCRIPTION OF PREFERRED EMBODIMENTS

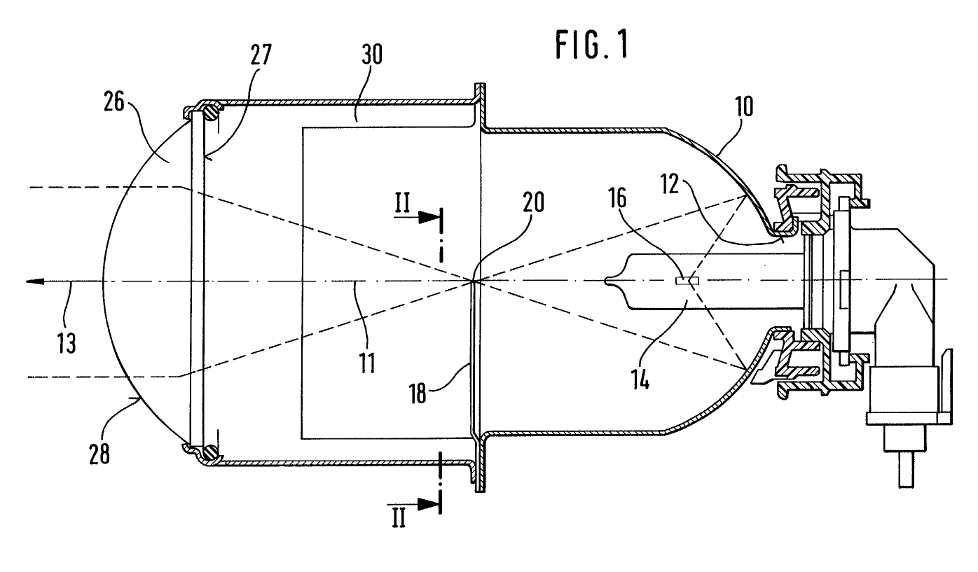

A headlight for a vehicle, in particular a motor vehicle, which is shown in FIGS. 1, 2, and 4 operates in accordance with a projection principles. The headlight serves for producing a screened light beam, in particular a low beam. The headlight has a reflector which is identified with reference numeral 10 and has preferably an ellipsoidal or an ellipsoid-like shape. The reflector 10 is provided with an opening in its apex region, and a light source 14 is arranged in the opening. The light source 14 can be formed as an incandescent lamp or a gas discharge lamp, and is provided with a light body which is formed correspondingly as an incandescent coil or a light arc. The light body 16 of the light source 14 is arranged substantially in the region of an inner focal point of the reflector 10 on the optical axis 11 of the reflector 10. The light emitted by the light source 14 is reflected by the reflector 10 as a converging light beam.

A screen 18 is arranged in the beam path of the light beam reflected by the reflector 10. It extends above the optical axis 11. The screen 18 can be located for example substantially in the region of the outer focal point of the reflector 10. The screen 18 can be arranged substantially in the plane of the front edge of the reflector 10 facing the light outlet direction 13. The screen 18 screens a part of the light beam reflected by the reflector 10, while the other part of the light beam passes over the screen 18. The light beam which passes over the screen 18 has a bright-dark limit which is determined by the upper edge 20 of the screen 18. A lens 26 is arranged after the screen 18 in the light outlet direction 13. It projects the upper edge 20 of the screen 18 as a bright-dark limit of the light beam exiting the headlight. The lens 26 is formed as a collecting lens. It has an approximately flat side 26 which faces opposite to the light outlet direction 13, and a convexly curved side 28 which faces in the light outlet direction. The convexly curved side 28 of the lens 26 has for example an aspherical curvature and can be subdivided into a plurality of differently curved segments. The lens 26 is held in a tube-shaped support element 30 in the end region facing in the light outlet direction 13. The support element 30 is mounted on the reflector 10 in its edge region which faces opposite to the light outlet direction 13, in particular on the front edge. The screen 18 can be mounted together with the support element 30, on the reflector 10.

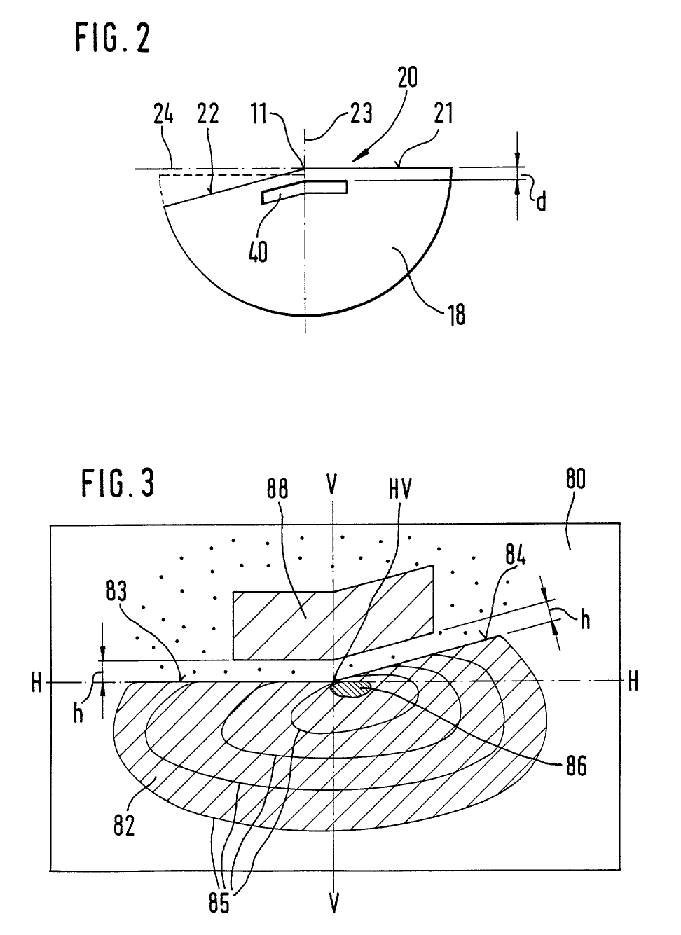

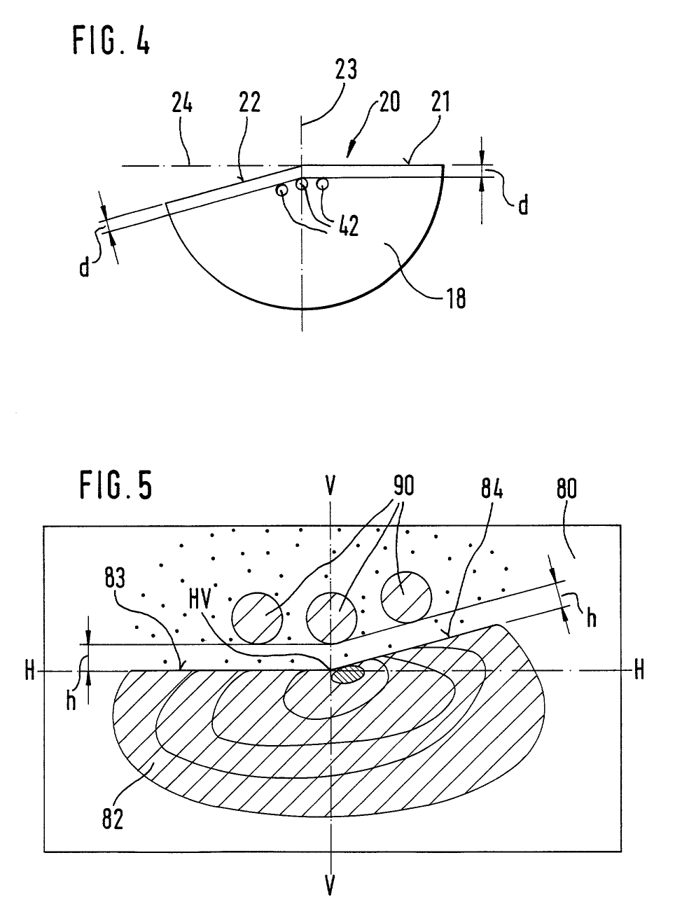

FIG. 2 shows the headlight in a cross-section with the screen 18 in accordance with a first embodiment. The shape of the upper edge 20 of the screen 18 can be seen from FIG. 2. It is also true for the subsequently described second embodiment of the screen 18 shown in FIG. 4. The upper edge 20 of the screen 18 has different portions 21, 22 which meet substantially in a vertical central plane 23 which contains the optical axis 11. The shown embodiments of the headlight are provided for the right side traffic so that the traffic side in front of the vehicle is right, while the counter traffic side is left. The portions 21, 22 of the upper edge 20 of the screen 18 are arranged so that the bright-dark limit on the traffic light is arranged in front of the vehicle higher than on the counter traffic side. For example the portion 21 of the upper edge 20 of the screen 18 extends at least substantially horizontally and substantially at a height of a horizontal central plane 24 which contains the optical axis 11. The portion 22 extends for example, starting from the vertical central plane 23, so that it is inclined downwardly. The angle of inclination of the portion 22 to the horizontal central plane 24 amounts preferably to substantially 15°.

The upper edge 20 of the screen 18 is projected through the lens 26 so that it is offset upwardly and laterally, so that the portion 21 forms a horizontal bright-dark limit portion on the opposite traffic side, and the portion 22 forms a raising bright-dark limit portion on the traffic side. The bright-dark limit of the light beam exiting the headlight has therefore a course which is required in accordance with European regulations. Alternatively, the portion 22 of the upper edge 20 of the screen 18, as shown in a broken line shown in FIG. 2, can extend at least approximately horizontally and deeper than the portion 21. The both portions 21, 22 therefore are connected with one another by a vertical or inclined intermediate portion.

A measuring screen 80 is arranged at a distance from the headlight and illuminated by the light emitted by the headlight. The measuring screen 80 represents the projection of a roadway located in front of the headlight and correspondingly illuminated by the headlight. The horizontal central plane of the measuring screen 80 is identified as HH while the vertical central plane is identified with VV. The horizontal central plane HH and the vertical central plane VV intersect in a point HV. The light which is reflected by the reflector 10, passes over the screen 18, passes through the lens 26 exits the headlight, and illuminates a region 82 on the measuring screen 80. The region 82 is limited from above by the bright-dark limit, which is produced by the upper edge 20 of the screen 18. The bright-dark limit has a horizontal portion 83 on the counter traffic side, which is produced by the portion 21 of the upper edge 20 of the screen 18. At the traffic side, the bright-dark limit has a raising portion 84 which is produced by the portion 22 of the upper edge 20 of the screen 18.

The distribution of the illumination intensities in the region 82 is identified with several lines 85 which have the same illumination intensities. In the region 82 the highest illumination intensities are provided in a zone 86 located closely under the bright-dark limit 83, 84 and substantially right of the vertical central plane VV. Above the bright-dark limit 83, 84 the measuring screen 80 is not illuminated by the light passing on the upper edge 20 of the screen 18 or is illuminated only poorly. The sharpness of the projection of the upper edge 20 of the screen 18 as the bright-dark limit 83, 84 is dependent on the projection properties of the lens 26. It is advantageous when the bright-dark limit 83, 84 is produced with a certain unsharpness, to avoid too high contrast which can be disturbing.

In order to provide a sufficient illumination above the bright-dark limit 83, 84, it is provided in accordance with the present invention that the screen 18 has at least one opening under its upper edge 20, through which the light reflected by the reflector 10 can pass. In FIG. 2 the screen 18 is shown in accordance with a first embodiment. Here an opening 40 is provided, which is formed as a slot. The extension of the opening 40 in a substantially horizontal direction is therefore greater than in the vertical direction. The longitudinal extension of the opening 40 is at least approximately parallel to the upper edge 20 of the screen 18, so that the distance d of the upper edge of the opening 40 from the upper edge 20 is at least approximately constant. The extension of the opening 40 in the vertical direction is at least approximately constant. The opening 40 has, in correspondence with the portions 21, 22 of the upper edge 20, a substantially horizontal portion and an inclined portion. The opening 40 is formed in a central region of the screen 18 at both sides of the vertical central plane 23. The extension of the opening 40 at both sides of the central plane 23 is substantially equal or can be different. The distance d of the upper edge of the opening 40 from the upper edge 20 from the screen 18 is preferably selected in dependence on the focal length f of the lens 26, so that d is approximately 0.02-0.05, in particular at least approximately 0.035 times the focal length f. The distance d is measured perpendicularly to the corresponding portion 21, 22 of the upper edge 20.

The light which is reflected by the reflector 10 passes through the opening 40 of the screen 18 and the lens 26, exits the headlight, and illuminates a region 88 on the measuring screen 80 shown in FIG. 3. The shape of the region 88 corresponds to the shape of the opening 40 so that the region 88 extends approximately parallel to the portions 83, 84 of the bright-dark limit. The distance h of the region 88 from the portions 83, 84 of the bright-dark limit is determined by the distance d of the opening 40 of the upper edge 20 of the screen 18. Because of the distance h between the region 88 and the portions 83, 84 of the bright-dark limit it is guaranteed that directly above the bright-dark limit no illumination or an illumination with a very low illumination intensity is provided, and a blinding of the opposite traffic participant is reliably prevented. However, traffic or information boards arranged at a great height and located in the region 88 are sufficiently eliminated. The dimensions and the shape of the region 88 can be varied by the corresponding selection of the dimensions and the shape of the opening 40 in the screen 18.

FIG. 4 shows the screen 18 in accordance with the second embodiment of the present invention. The screen 18 as the first embodiment, has an upper edge 20 with the portion 21 and 22. The screen 18 is provided with a plurality of openings 42 which are located above its upper edge 20. They are distributed along a line which extends substantially parallel to the portion 21, 22 of the upper edge 20. The openings can be formed for example as round openings or can have any cross sectional shape. They can be produced for example by punching of the screen 18. In the embodiment shown in FIG. 4, three openings 42 are provided. A central opening 42 is arranged substantially in the region of the vertical plane 23, while both other openings 42 are arranged at the same distance from the central plane 23. The distance d between the upper edges of the openings 42 and the portions 21, 22 of the upper edge 20 of the screen 18 amounts, as in the first embodiment, preferably to substantially 0.02-0.05 times, in particular at least approximately 0.035 times of the focal length f of the lens 26.

FIG. 5 shows the measuring screen which is illuminated by the light emitted by the headlight with the screen 18 in accordance with the second embodiment. The light which is reflected by the reflector 10, passes over the upper edge 20 of the screen 18, passes through the lens 26, exits the headlight and also illuminates the region 82 which is limited from above by the bright-dark limit 83, 84. The light which passes through the opening 42 of the screen 18 and the lens 26 illuminates the regions 90 of the measuring screen 80. The shape and position of the region 90 corresponds to the shape and position of the openings 42 of the screen 18, so that the regions 90 are distributed at least approximately along the portions 83, 84 of the bright-dark limit. The distance h of the region 90 from the portion 83, 84 of the bright-dark limit is determined by the distance d of the openings 42 from the upper edge 20 of the screen 18. Because of the distance h between the regions 90 and the portions 83, 84 of the bright-dark limit, it is guaranteed that directly above the bright-dark limit, no illumination is provided or an illumination with a very low illumination intensity is provided, and a blending of the opposite traffic participant is reliably prevented. However traffic or information boards arranged at a great height and located in the region 90 are sufficiently illuminated. The dimension, shape and position of the region 90 can be varied by the corresponding selection of the dimension, shape and position of the openings 42 of the screen 18.

In accordance with the present invention it can be also provided that the screen 18 can have a plurality of openings which are located in a region at a distance from the upper edge 20, for example in form of a perforation. Additionally, to the above shown embodiments of the screen 18 with the openings 40 or the openings 42, also further features for illumination of the measuring screen 80 above the bright-dark limit 83, 84 can be provided.

It will be understood that each of the elements described above, or two or more together, may also find a useful application in other types of constructions differing from the types described above.

While the invention has been illustrated and described as embodied in Headlight for Vehicle Operating in Accordance with Projection Principle, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A headlight for a vehicle operating in accordance with the projection principle, comprising a light source; a reflector which reflects light emitted by said light source as a converging light beam; a screen arranged in a beam path of the light beam reflected by said reflector and screening a part of the light beam; a lens arranged after said screen in a light outlet direction for projecting an upper edge of said screen as a bright-dark limit of a light bundle exiting the headlight, so that a part of the light bundle reflected by the reflector illuminates at least a region arranged at a distance above the bright-dark limit, said screen being provided with at least one opening which is located at a defined region below said upper edge of said screen and formed so that a part of the light beam reflected by said reflector passes through said opening and illuminates at least one region above the bright-dark limit.

2. A headlight as defined in claim 1, wherein said at least one opening is slot-shaped and extends at least substantially parallel to said upper edge of said screen.

3. A headlight as defined in claim 1, wherein said screen is provided with a plurality of said openings, which are arranged along a line extending at least substantially parallel to said upper edge of said screen.

4. A headlight as defined in claim 1, wherein a distance from said at least one opening from said upper edge of said screen perpendicular to said upper edge amounts to substantially 0.02-0.05 of a focal length of said lens.

5. A headlight as defined in claim 1, wherein said distance amounts to substantially 0.035 of the focal length of said lens.
